(19) United States
(12) Patent Application Publication
(10) Pub. No.: US 2017/0275024 A1
(43) Pub. Date: Sep. 28, 2017

(54) SYSTEM AND METHOD FOR DOCKING UNMANNED AERIAL VEHICLES (UAVS)

(71) Applicant: ANDREW BENNETT, Belmont, MA (US)

(72) Inventor: ANDREW BENNETT, Belmont, MA (US)

(21) Appl. No.: 15/082,498

(22) Filed: Mar. 28, 2016

(51) Int. Cl. B64F 1/12; B64F 5/00; B64D 5/00; B60L 11/18; G05D 1/00; G05D 1/10; B64F 1/00; B64C 39/02

(52) U.S. Cl. CPC B64F 1/12; B64F 1/007; B64F 5/0018; B64C 39/024; B60L 11/1822; B60L 11/1833; G05D 1/0011; G05D 1/101; B64D 5/00; B60L 2200/10

(57) ABSTRACT

This document describes a system and method through which unmanned aerial vehicles (UAVs) can be docked, with a device that can secure the UAVs, and information can be transmitted to and from such UAVs. The UAVs are secured through the use of magnetic fields. The system also includes a means for transmitting information between the docking system itself, the UAV(s) and/or between the docking system and a command center, which may be a notable distance from the docking system, or among the docking system, the UAV(s) and the command center.

### COPYRIGHT NOTICE

A portion of the disclosure of this patent application contains material that is subject to copyright protection. Noting the confidential protection afforded non-provisional patent applications prior to publication, the copyright owner hereby authorizes the U.S. Patent and Trademark Office to reproduce this document and portions thereof prior to publication as necessary for its records. The copyright owner otherwise reserves all copyright rights whatsoever.

### ABSTRACT

This document describes a system and method through which unmanned aerial vehicles (UAVs) can be docked, with a device that can secure the UAVs, and information can be transmitted to and from such UAVs. The UAVs are secured through the use of magnetic fields. The system also includes a means for transmitting information between the docking system itself, the UAV(s) and/or between the docking system and a command center, which may be a notable distance from the docking system, or among the docking system, the UAV(s) and the command center.

### FIELD OF INVENTION

The invention relates generally to an apparatus to which unmanned aerial vehicles (UAVs) can be secured (docked) using magnetic fields and through which information can be transmitted to and from such UAVs, and a method of securing and communicating with such UAVs.

### BACKGROUND

The uses of UAVs and the advances in their technology have grown substantially as computer-processing speeds have increased, stronger lighter materials have been utilized in UAV construction, and equipment component sizes have decreased. UAVs are increasingly being used for various activities and purposes, including, for example, numerous research applications. In some of the research applications, for example, UAVs gather information over vast areas of land, water, air space, or combinations of the foregoing. The scope of such research and other uses is at times limited, however, by the flying range of the UAVs, weather conditions and other factors.

The flying range, for example, is itself influenced by several factors. For instance, the needs for the UAV to return to its point of origin to refuel/power up and to, as applicable, offload samples limit the distance the UAV can fly away from the point of origin and return successfully. In some such cases, the UAVs can safely travel no more than half their maximum distance or flying-time from the point of origin and then must commence the return journey to the origin.

Another limitation on the use of certain UAVs—ones that are slated to land and spend time at distal locations away from their points or origin—is the ability for the UAV operators/users, controlling the flight at the origin, to land and secure the UAVs at the remote locations. Typically, the operator/user at the origin is expected, at best, to land the UAVs at the distal location with the help of personnel at such remote location, to transfer control to such other personnel, to have such personnel secure the UAVs after they have landed, or combinations of the foregoing. If there are no remote personnel, then the operator/user at the origin might employ cameras on the UAV or at the remote landing location to assist in such landing, assuming there is a signal connection between the operator/user at the origin, the UAV and possibly the landing location (if, for example, a camera is situated there).

Without personnel at the remote locations to secure the UAVs, given their typical small size and light weight, there is also the greater possibility of misappropriation of the UAV (depending on the openness of the landing area) and/or damage from adverse environmental conditions (e.g., structure/UAV damage from movement caused by wind forces). Typically, however, the securing of the UAVs calls for personnel to be at or travel to the remote location(s) to physically engage straps, clips, bolts or some other form of mechanical constraints, the engagement of which being “hands-on” activities.

Another personnel-requiring activity typically is the downloading/offloading of, for example, data and samples from the UAVs. With UAVs that collect data and/or samples as part of their mission, a human operator/user is traditionally engaged, in many instances, at the landing location (be it at the point of origin or at a remote location) to retrieve the UAVs' payload (e.g., data and/or samples collected during the UAVs' operations). As with the securing process, the need to engage personnel for such retrieval is a notable use of human resources and possibly an element of the process that lengthens the duration of the operation as a result thereof (e.g., with the increase wait for the availability of personnel to perform the retrieval or the travel time need for the personnel to arrive at the landing location to perform the retrieval).

The foregoing describes some of the shortfalls of the prior operations of UAVs (notable in their use, landing, securing, and the process of data/sample retrieval). The present inventions (both the apparatus and the method) are designed and have been developed to address these considerations and other challenges in the operation of UAVs.

### SUMMARY

The present invention comprises a system and method through which unmanned aerial vehicles (UAVs) can be docked and information can be transmitted to and from such UAVs. One embodiment of the invention is a docking system capable of securing at least one UAV. Such system comprises at least one surface configured to accommodate an area of UAVs in in close proximity with the surface(s). Another element of the system would be a means for securing the UAVs in such close proximity to surface(s) through the use of magnetic fields. The system also includes a means for transmitting information between the docking system itself and the UAV(s). In addition to the transmission of information between the docking system and the UAVs, there is also a means for transmitting information between the docking system and a main control center, which may be a notable distance from the docking system. The invention in this embodiment would also include a means for transferring, from the docking system, a source of energy needed to power/refuel the UAVs.

Other embodiments of the inventive apparatus may include means for protecting the UAVs from unfavorable environmental conditions or means of extracting samples from the UAVs (e.g., a means of taking off and reloading a consumable or other material). Still other embodiments may include means of extracting certain information from UAVs, uploading information to same, inspecting the physical condition of such UAV, and cleaning them. Still another embodiment of the invention includes use of the magnetic fields that lock the UAV(s) in physical contact with a surface with the docking system. A more sophisticated embodiment of the present invention includes means for monitoring environmental conditions and other local circumstances in geographical proximity of the docking system and means for analyzing samples.

The invention as a method would comprise the step of transmitting signals between docking locations and a main control location. This communication could be used, in part, to facilitate the transmitting of signals between

UAVs and the docking locations. With the communication between the docking locations and the UAVs established (e.g., for guidance during travel), the UAVs can be positioned, using this embodiment of the inventive method, in close proximity with the docking locations. Thereafter, the UAVs can be secured in close proximity with the docking location through the use of magnetic fields. If and as needed, the inventive method could include the step of transferring energy to power/refuel the UAVs from the docking locations.

Another embodiment of the inventive method includes the step of protecting UAVs from unfavorable environment conditions. The step of extracting and/or storing samples from the UAVs may also be added. In another embodiment, the invention includes the step of preparing UAVs for deployment. Such preparation could include, for example, the extraction of certain information from such UAVs, the uploading of information to such UAVs, the inspection of the physical condition of such UAVs, and the maintenance of the UAVs. Still in another embodiment of the present inventive method, the magnetic fields lock an area of the UAVs in physical contact with a surface of the docking locations. The signal between the docking locations and the distal location main control may be transmitted via over-the-air technology and the securing the UAVs may be made while the docking locations are mounted on movable objects. The method may also have the transmission of information between the docking locations and the UAVs while the UAVs are not in close proximity with the docking locations. As such, an additional step could be the coordinating of travel of the UAVs to and from the docking locations. The foregoing could be accomplished by transmitting information between the docking locations and the UAVs that can control the flight time of, destination of, information and sample gathered by, and other operations of the UAVs. The inventive method may also include the steps of monitoring environmental conditions and other local circumstances in the geographical proximity of the docking locations and analyzing samples. Further, the securing means, when it employs magnetic fields, could facilitate a physical connection and transmission of information to and from the UAVs (e.g. holding still a UAV while a physical connector is engaged, and the connector could be used for information transfer, fuel transfer, handling of other consumables, and other operations.)

### BRIEF DESCRIPTION OF THE FIGURES

FIG. 1 shows a top view of an embodiment of docking element of the present invention.

FIG. 2 shows an arrangement of embodiments of the docking elements, UAVs and a control center.

FIG. 3 shows a side view of an embodiment of the docking element of the present invention with a transfer conduct, motor and retractable cover.

FIG. 4 shows a side view of an embodiment of the docking element with a hovering UAV, where docking element includes a storage area, a mechanical arm and a collector.

FIG. 5 shows an embodiment of the present invention with three docking elements.

FIG. 6 shows an embodiment of the docking element resting in the cargo-holding area of a vehicle.

FIG. 7 shows an embodiment of the docking element, a set of UAVs and a command center where signals are transmitted between the UAVs and both the docking element and the command center.

### DETAILED DESCRIPTION

The inventive docking system provides a location for one or more UAVs to land and to be secured. In one preferred embodiment of the present invention, the docking system, when deployed a distance from the UAVs points of origin, is capable of communicating with the human operator/user at the points of origin or at different locations, or, if the operation is more automated, with the programmed equipment at such point of origin or different location. The UAVs accommodated by the docking system could be rotary/hovering, fixed-wing or any combination. The docking system is fundamentally the same, but may be adapted to the needs of specific UAVs (e.g. when a sample removal and storage system are desirable due to the missions of the UAVs). The main control center may comprise software that includes a mission planner and a user interface and could be run on any computer that has networking and/or satellite communications access. The inventive docking system has the advantages of reach (the UAV can fly to any location within its operational radius), speed (relatively instant response), timing (the UAV can launch at any time, barring unforeseen conditions) and mobility (the UAV can go anywhere with a docking system that can be positioned almost anywhere).

In general, the apparatus of the present invention allows UAVs to be positioned in a location where the UAVs are intended to stay for a relatively long time before being deployed or redeployed. The UAVs can be any vehicle of convenience (e.g. quadcopters, hexacopters, fixed-wing, or helicopters). Such vehicles would preferably include wireless communications technology through which they could communicate with the ‘main control center’ and/or the docking systems and may also (or alternatively) include an autonomous autopilot capable of navigation. For cluttered environments, the UAVs would preferably include functionality through which they could ‘sense and avoid’. Also, the UAVs could preferably be capable of carrying a mission-specific payload (camera, sample collector, other sensors).

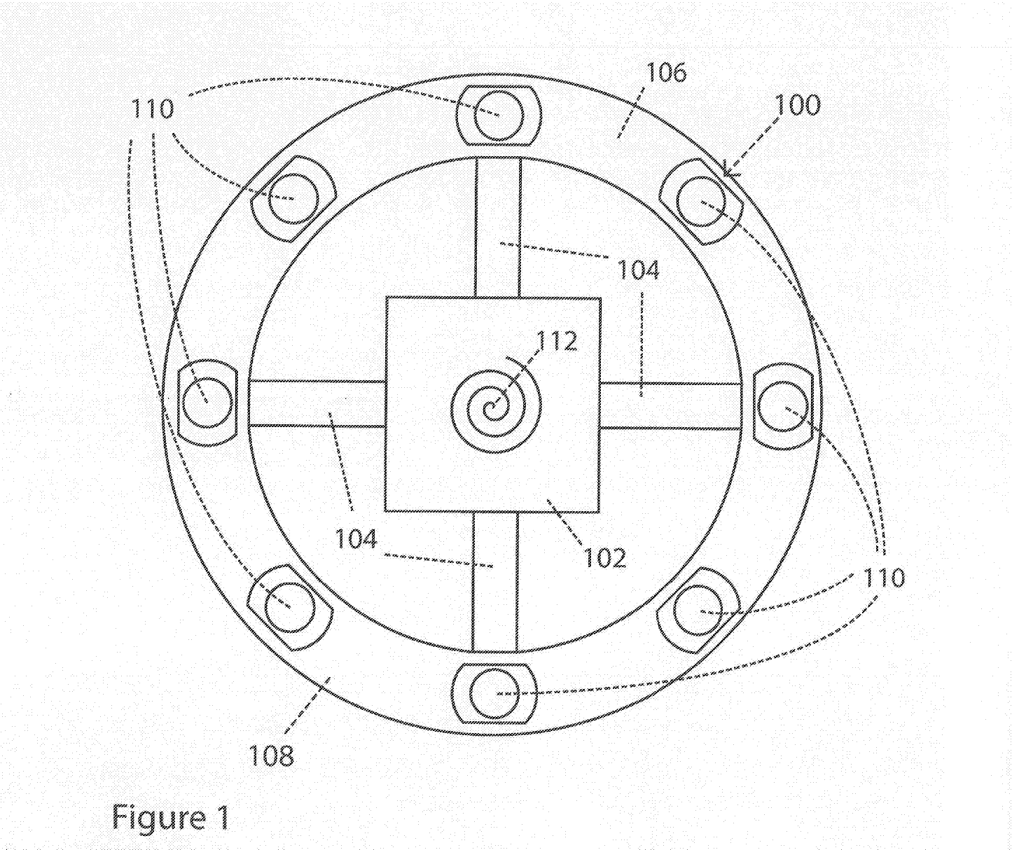

FIG. 1 shows one embodiment of the present invention—docking system 100. Base 102 is the foundation of the docking system 100. One of ordinary skill in the art would know that base 102 could be configured as a stand that merely sits on the ground or other surface or could be secured through fasteners of other mechanism to hold docking system 100 in place. For example, base 102 could be bolted on a platform located in a remote geographical area, strapped to the deck of a boat traveling at sea, attached to a motor vehicle or otherwise fixed in association with a desired location or transporting structure.

Docking system 100 also has rods 104 that connect platform 108, with surface 106, to base 102. As shown in FIG. 1, surface 106 is at the top of platform 108 and platform 108 is in the space of a ring. One of ordinary skill in the art would know that the dimensions and configuration of surface 106 could be different as the dimensions, configuration and other aspects of platform 108 are changed. It is also possible that surface 106 is an outer area of base 102. Depending upon the desired operation and placement of docking system 100, surface 106 could be situated under base 102 (for example, if docking system 100 was to be hung in its desired location with UAVs docked under it) or on the side of base 102 (if, for example, the applicable UAV is to be secured on the side of docking system 100).

Preferably, surface 106 is configured to accommodate an area of at least one UAV in at least in close proximity with surface 106. As suggested elsewhere in this document, docking system 100 may be used in connection with UAVs of various sizes, capabilities, designs, and configurations. The ability to accommodate a particular UAV is somewhat dependent upon the portion of, and the manner in which, the UAV is to be secured by, for example, docking system 100. The UAV would need to be positioned close enough to that operational part of docking system 100 that will secure the UAV. Accordingly, the access to surface 106 in the proximity of the ‘docking’ area needs to be adequate. In particular embodiments of the present invention, the accommodation for the area of surface 106 is sized and configure to allow therewith the proximate locating of an adequate area of a UAV landing gear. Such configurations may also have the securing means in close proximity to the accommodating area while other configurations could have the securing means within the accommodating area. In a further embodiment of the invention, the accommodation area may be adjustable for docking UAVs of various sizes and configurations.

FIG. 1 also shows magnets 110. In this particular embodiment of the present invention, there are four magnets 110 and they are spaced evenly within platform 108. In this configuration, magnets 110 can secure the UAVs by generating a magnetic field that attracts a desired portion of the UAVs (such as, for example, metal landing gear) toward platform 108 and then locks that portion of the UAVs in close proximity with platform 108. When the magnetic field is strong enough, the portion of the UAVs may be held in contact with magnets 110, platform 108, or both. One of ordinary skill in the art would know that there are numerous ways to generate the desired magnetic fields through, for example, the use of one or more magnets, differing positioning of magnets in and around the docking system, and the use of other mechanisms (besides magnets) that can generated desirable levels of magnetic forces. In a preferred embodiment of the present invention, the power of such magnetic fields can be varied such that, for example, a higher level of power is used to secure the UAVs when docked and the power is decreased and/or turned off for disengagement of the UAVs. Further, it is preferable that the power level could be increased during docked times as needed due to changes in the weather and other conditions in the environment of the docking system.

Connectors 112 are also shown in FIG. 1. In the embodiment of the present invention shown in FIG. 1, base 102 could contain, for example, electronics capable of communicating with UAV. In this embodiment, connectors 112 are the elements that can be physically connected to UAVs that have compatible ports. One of ordinary skill in the art would recognize that the communication between UAVs and the inventive docking system could also be accomplished through the use of wireless technology. Further, connectors 112 could be engaged with the UAVs by the UAVs causing the connection (e.g., coming to rest with the positioning of connectors 112 within the applicable ports of the UAVs) or with, for example, mechanics of base 102 moving connectors 112 into such ports.

In a particular preferred embodiment, docking system 100 could have the ability to communicate wirelessly with the UAVs and with one or more human operators/users situated in one or more locations that are distal from the location of docking system 100. In addition, the docking system could be adapted to capture, release and store UAVs against any weather.

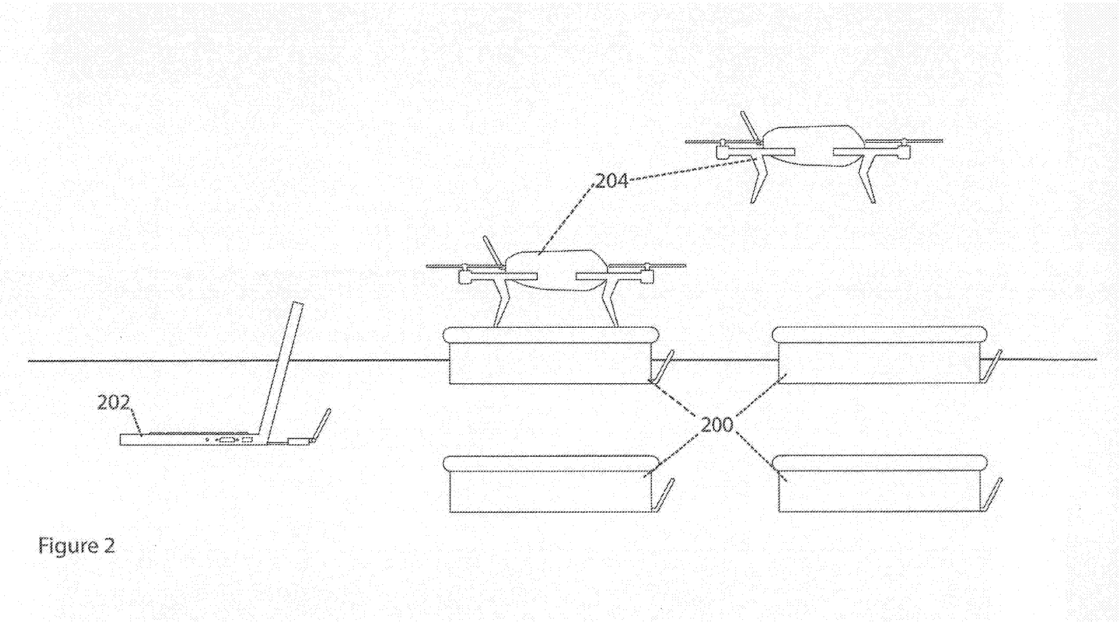

FIG. 2 shows multiple deployments of the present inventive docking systems 200 and a depiction of remote location 202. In a preferred embodiment, one or more docking systems 200 can be in communication with remote location 202 through the transmission of information between one or more docking systems 200 and remote location 202. An operator/user could, thus, operate remote location 202 as a main control center. In such a configuration, the operator/user could operate functions of applicable docking systems 200. The human operators/users and/or the equipment at remote location 202 could coordinate some or all of the activities of docking systems 200. If networked, the main control center could communicate and coordinate the activities of more than one docking system 200, while also influencing the mission of UAVs 204. Such center could accomplish this coordination with UAVs 204, for example, through signals transmitted first to one or more authorized docking systems 200. Amongst the components of the networked elements, the main control center could be tasked with high level planning and administration of human operator/user authorizations.

In a further embodiment, remote location 202 could be in communication with UAVs 204. In still a further embodiment, one or more docking systems 200 could also (with remote location 202), or could instead (of remote location 202), be in communication with UAVs 204. In certain embodiments, the transmission of information and other communication could be accomplished through over-the-air (e.g., wireless) communications, such as, for example, through radio signals, cellular technologies or other means, now known or to be known. An individual UAV could fly circuits from docking systems to other docking location(s), thereby extending the range of the UAV.

In a more automated configuration, missions for UAVs 204 are planned by, for example, an autonomy engine, situated at remote location 202 and/or within docking system 200. Such an engine could calculate the paths UAVs 204 would fly, what data they would collect, how many UAVs would be deployed, and whether to place UAVs 204 in ‘sleep’ or ‘wake up’ mode (for very long endurance missions or missions that are waiting for specific conditions, such as immediately after a storm, during a migration, etc.). Such an engine could also notify docking systems 200 of upcoming weather conditions to assist local planning.

The human operator/user could program the docking system via the user interface. He/she could program missions, monitor UAVs in communication with the docking systems, set global parameters, choose specific targets, and check the health of the docking system or any element thereof. Such human operators/users could also, for example, select specific docking system locations or UAVs and monitor them closely. In addition to high-level mission parameters, the human operators/users could select specific UAVs or docking systems for direct access to data where the docking system requires human intervention (e.g. the human is required to select or approve a target).

Docking systems 200 may also be able to communicate with an incoming UAV 204 with a notice to end its mission prematurely due to adverse weather conditions at, or anticipated for, the locations of docking systems 200. Accordingly, docking systems 200 may be equipped with weather monitoring equipment, external cameras and/or other sensors appropriate to the mission/location they are in. As discussed in more detail below, some docking systems may also have the ability to store and/or process physical samples.

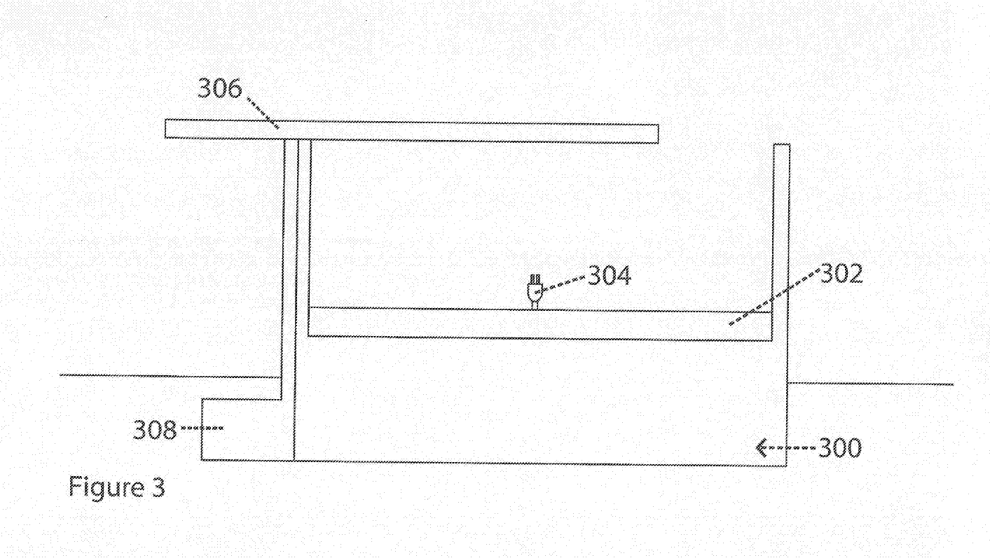

FIG. 3 shows docking system 300 with base 302 and transfer conduct 304. With this embodiment of the invention, a form of energy for UAVs (for example, fuel or electricity) could be transferred from the base to the UAVs. In another embodiment of the present invention, transfer conduct 304 also has the capabilities and functionality of connector 112, with the ability to also facilitate the transfer of information between UAVs and docketing system 300. One of ordinary skill in the art would know that there are a number of ways of and configurations for physically connecting a UAV to docking system 300 to enable energy and other transfers. This particular embodiment also has retractable cover 306 and motor 308. In this configuration, motor 308 can be used to move retractable cover 306 over a UAV docked in docking system 300, thus providing some level of protection from the surrounding environment and changing weather conditions. One of ordinary skill in the art could conceive of other means of protecting a docked UAV (e.g. wholly or partially, remotely or locally activated, hard or soft material, and other options).

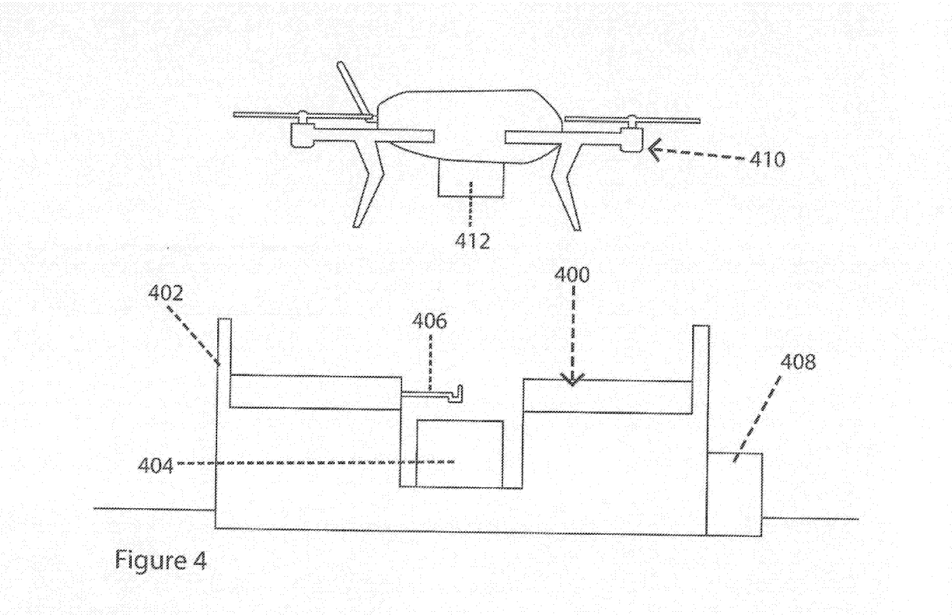

FIG. 4 shows docking system 400 with base 402 and storage area 404. In this configuration of the present invention, storage area 404 could be used, for example, as a repository for samples (e.g., material, consumables, artifacts and possibly more) collected by UAV 410. Mechanical arm 406 could be used to grasp, for example, a container attached to UAV 410 that holds sample 412. Thereafter, mechanical arm 406 could be used to lower, in this case, the container and/or the sample therein into storage area 404. One of ordinary skill in the art would know that the configuration of storage area 404 and the extraction system (used to move sample 412 from UAV 410 to storage area 404) may vary in design and operation. Accordingly, if by chance UAV 410 is lost, sample 412 will be preserved. This capability and functionality of the docking system 400 adds to its usefulness over long periods of time—for as long as it is functional and in place. In another embodiment of the present invention, docking system 400 has the capacity to accept delivery of physical samples of interest, such as, for example, samples of water, air, vegetation, and more. The enhanced version of this embodiment also includes the capability of analysis in-situ or preparation of the sample for analysis after such time as a human operator/user recovers the sample from storage area 404.

By way of further example, docking system 400 could also be equipped with the capacity to receive, using a mechanism like mechanical arm 406, packages and documents. For example, docking system 400 can be on standby to receive/transport material or documents when needed, regardless of time of day. One advantage of such a system is lower cost delivery—relative to the costs of a human courier. Examples of such an embodiment of docking system 400 in operation include ship-to-shore document transfer, rapid part delivery in large operations such as mining and forestry.

Mechanical arm 406 might also be conversely used to load materials from, for example, storage area 404 or elsewhere onto UAV 410. Such an operation could be part of the preparation of UAV 410 for its mission. Other means could of course also be used for such preparation and such preparation could include, for example, the extraction of certain information from a UAV, the uploading of information to the UAV, inspection of the physical condition of UAV, and the other maintenance thereof, such as cleaning.

Via collector 408, docking system 400 also individually collects samples in a fashion, for example, similar to the collection performed by UAV 410. This ‘parallel’ operation could be used, for example, to collect contemporaneous data from the UAVs and the docking location for comparison of readings from their separate locations. As another example, through the use of collector 408, docking system 400 could collect a sample during a transient event that is hard to reach or predict and, in essence, warn the UAVs. Other examples include samples collectible at the location of docking system 400, for comparison with the readings from the UAVs and/or independently, are readings of post-storm runoff, plant blooms, migrations, eruptions, and more.

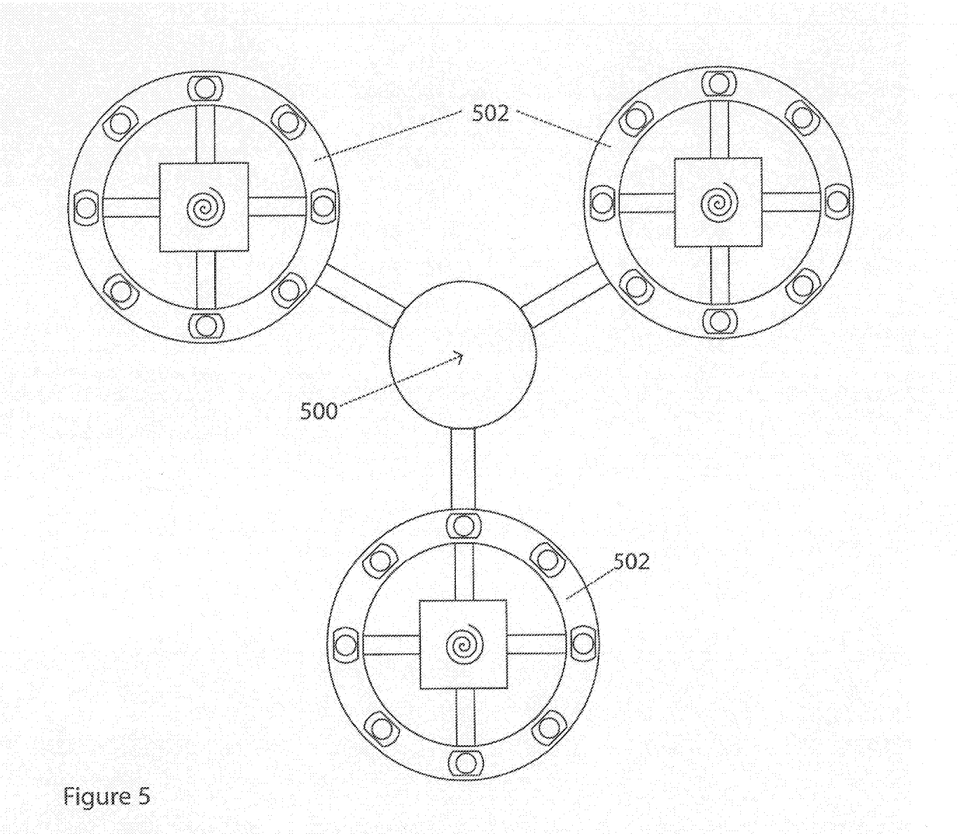

FIG. 5 shows docking system 500 which has, in essence, three surfaces 502, each of which is configured to accommodate an individual UAV and through which such individual UAV may be secured. In this particular embodiment, the UAVs may be secured simultaneous or one or more of surfaces 502 may be open while one or more of other surfaces 502 each secure a UAV.

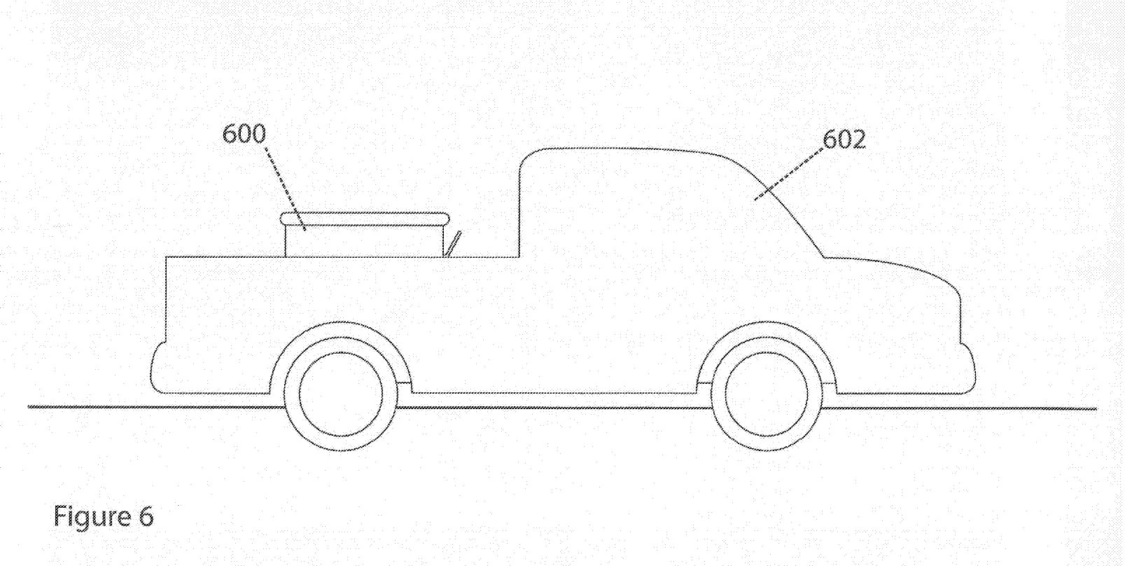

FIG. 6 shows docking system 600 mounted on land-bound vehicle 602. This mounting may be accomplished through a variety of means in differing configurations. One of ordinary skill in the art would realize that docking system 600 could also be conceivable mounted on water-operational vehicles and aerial apparatus (the latter allowing a UAV to be, for example, docked to another inflight apparatus). Other movable mountings are also possible. Conversely, as stated above, docking system 600 could be mounted on, for example, the top of a building after or instead of being mounted on a movable apparatus.

Since docking system 600 could be be permanently situated (once located in a desirable place), it can be used to perform long-term event sampling. For example, docking system 600 could collect samples at intervals over relatively long periods time (e.g. a year, a season or a slowly-evolving event). The analyses and/or stores samples by docking system 600 over such time can help to create a more complete picture of an event. Examples of the kinds of events that docking system 600, when permanently fixed, could be engaged to sample include Harvard Forest Monitoring (a multi-year data collection project), sampling around an active volcano, a seasonal event, monitoring an oyster reef over a winter, and more.

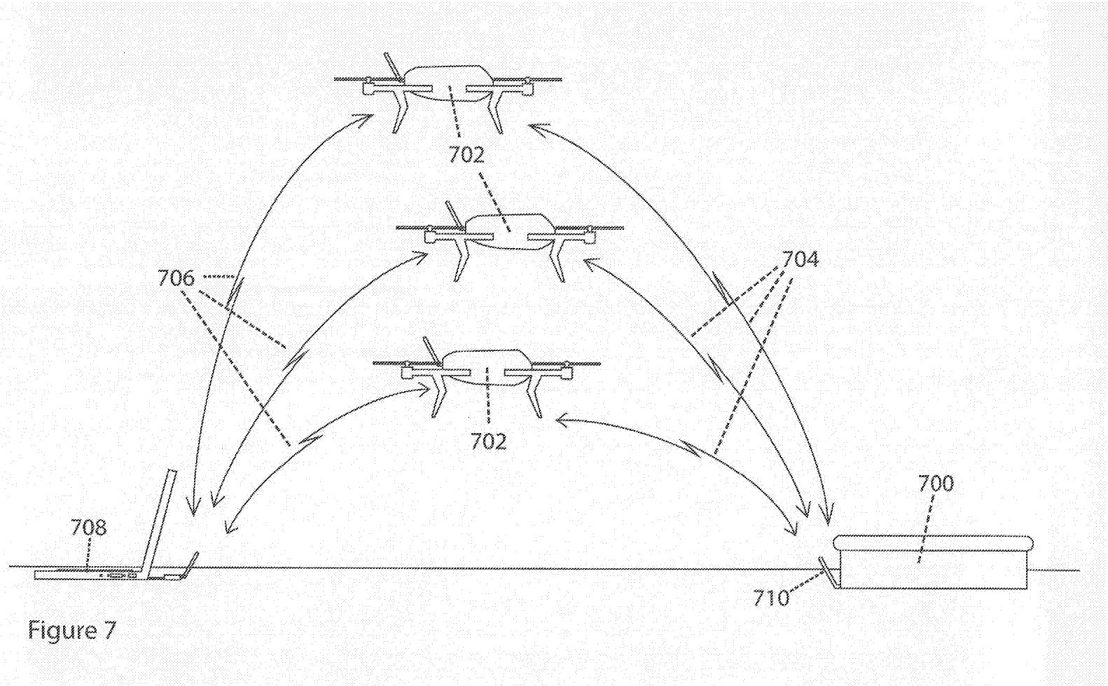

FIG. 7 shows an example of how a multitude of UAVs 702 could interface with a single docking system 700. Signals 704 transmit information between docking system 700 and UAVs 702. In such a configuration, an operator/user could coordinate the missions of UAVs 702 relative a specific location. Further, docking system 700 could be in communications with command center 708 through signal 706. Such facility to communicate could allow to an operator/user to thus, through this particular embodiment of the invention, coordinate the activities of UAVs 702 from a location remote from docking system 700 and, if and as necessary, to also remotely manage the activities of docking system 700. Another element a particular embodiment of the present invention is a means for transmitting information between, for example, docking system 700 and command center 708 to coordinate travel by UAVs 702 to and from docking system 700. Such information could include, for example, data to control the flight time of, destination of, information and sample gathered by, and other operations of one or more UAVs 702. Monitor 708, attached to docking system 700, provides a means for monitoring, for example, environmental conditions and other local circumstances in the geographical proximity of such docking system. Other analysis, for example, the analysis of samples gathered by UAVs, could be conducted by evaluator 710.

Docking system 700 could also be ‘programmed’ to deploy UAVs 702 (e.g. releasing the magnetic hold) at random intervals. An example of such a process in use would be docking system 700 releasing one of two UAVs 702 so they can be deployed to monitor a facility at random intervals, having one of UAVs refueling while the other is used to conduct surveillance. Such scheduling could, for example, help prevent someone from avoiding detection or deter ‘bad acts’ by a person that would otherwise not be as easily observed. Examples of such uses include monitoring of material caches in remote staging areas, monitoring around sensitive facilities, ensuring compliance to prevent pollution discharges, security around offshore facilities, military base security, and more.

As mentioned earlier, the UAVs could sit in the docking systems, in some cases, immune to local weather conditions, until the time to deploy/redeployed. They then could perform their missions and return to the docking systems for servicing or to await recovery. In one specific embodiment of the present invention, the docking system is capable of securing UAVs, store them in any weather, recharge or swap out batteries, clean the UAV, extract samples from the UAVs for storage or analysis, and service the UAVs. Such a version of the docking system is intended to act as a combination hangar, storage unit and base of operations for the UAVs. As mentioned, the docking system can be equipped with satellite and/or cellular communications to communicate with the human operators/users as well as wireless communications to send signals to and receive them from the UAVs.

With regards to the inventive process, the present invention is a method of communicating with and securing one or more UAVs. This process includes the step of transmitting a signal between a docking location and a distal location, such as, for example, a main control center. The process also includes transmitting a signal between such docking location and UAVs. The foregoing enables the positioning such UAVs in in close proximity with the docking location. Once the applicable UAVs are in the desired position, they can be secured in close proximity with the docking location through the use of magnetic fields. After the UAVs are adequately secured, any energy needed to power the UAVs can be transferred from the docking location to the applicable UAVs.

In a further embodiment of the present invention, the process includes the protection of one or more the UAVs from unfavorable environment conditions. Further, the present invention may include the extraction of samples from such UAV(s). If there is capacity, the samples may be stored in or near apparatus at the docking location. Conversely or in addition, the process could include the preparation of the UAV(s) for deployment. Such preparation could include the extraction of certain information from such UAV, the uploading of information to such UAV, inspection of the physical condition of such UAV and the maintenance of the UAVs. In a preferable version of the present invention, the UAVs are secured in close proximity to the accommodating area at the docking location. This area would facilitate the use of the magnetic fields in locking a docking area of the UAVs into physical contact with a surface of the docking location.

Also, in a specific practice of the present invention, the signal between the docking location and the distal location (e.g., a main control center) is transmitted via over-the-air technology. In an optional practice, the securing of the UAVs can be accomplished while the docking location is mounted on a movable object. Further, the transmission of information between the docking location and the UAVs could occur while such UAV are not in close proximity with the docking location.

With respect to the missions of the UAVs, the practice of the invention may include coordination of the travel of the UAVs to and from the docking location. This coordination may be accomplished in part by the transmission of information between the docking location and the UAVs, with such information being capable of controlling the flight time of, destination of, information and sample gathered by, and other operations of the UAVs. The monitoring of environmental conditions and other local circumstances in the geographical proximity of the docking location may also be part of the practice of the present invention, along with the analyzing of samples. Further, the securing means, when it employs magnetic fields, could facilitate a physical connection and transmission of information to and from the UAVs (e.g. holding still a UAV while a physical connector is engaged), and the connector could be used for information transfer, fuel transfer, handling of other consumables, and other operations.

### ADDITIONAL THOUGHTS

The foregoing descriptions of the present invention have been provided for the purposes of illustration and description. It is not intended to be exhaustive or to limit the invention to the precise forms disclosed. Many modifications and variations will be apparent to the practitioner of ordinary skilled in the art. Particularly, it would be evident that while the examples described herein illustrate how the inventive apparatus may look and how the inventive process may be performed. Further, other elements/steps may be used for and provide benefits to the present invention. The depictions of the present invention as shown in the exhibits are provided for purposes of illustration.

The embodiments were chosen and described in order to best explain the principles of the invention and its practical application, thereby enabling others of ordinary skill in the art to understand the invention for various embodiments and with various modifications that are suited to the particular use contemplated.

1. A docking system capable of securing at least one unmanned aerial vehicle comprising:
at least one surface configured to accommodate an area of at least one such vehicle in at least in close proximity with such at least one surface;
means of securing the position of at least one such vehicle in such close proximity to such at least one surface through the use of magnetic fields;
means for transmitting information between the docking system and at least one such vehicle;
means for transmitting information between the docking system and a distal location [main control]; and
means for transferring, from such docking system, a source of energy need to power at least one such vehicle.

2. The docking system of claim 1 further comprising means for protecting at least one such vehicle from unfavorable environment conditions.

3. The docking system of claim 1 further comprising means extracting [samples] from at least one such vehicle.

4. The docking system of claim 3 further comprising a means of storing such samples.

5. The docking system of claim 1 having more than one surface configured to accommodate at least one vehicle wherein more than one such vehicle can be secured at a time.

6. The docking system of claim 1 capable of securing differing vehicles at differing times in close proximity with one distinct surface.

7. The docking system of claim 1 further comprising means for preparing at least one such vehicle for deployment.

8. The docking system of claim 7 wherein such preparation of at least one such vehicle includes the extraction of certain information from such vehicle, the uploading of information to such vehicle, inspection of the physical condition of such vehicle and the maintenance of the vehicle [cleaning].

9. The docking system of claim 1 wherein the accommodation for the area of such at least one vehicle includes the existence of an area of the surface sized and configure to allow therewith the proximate locating of an adequate area of such vehicle's docking surface.

10. The docking system of claim 9 wherein the securing means is in close proximity to the accommodating area.

11. The docking system of claim 9 wherein the securing means is within the accommodating area.

12. The docking system of claim 1 wherein the magnetic fields of the docking system are used to lock the docking area of at least one vehicle in physical contact with a surface with an accommodating area.

13. The docking system of claim 1 wherein the distal location includes means for communication with the docking system via at least one over-the-air technology.

14. The docking system of claim 1 further comprising means of mounting securing such system to a movable apparatus.

15. The docking system of claim 14 wherein the movable apparatus is a vehicle for transport over water.

16. The docking system of claim 14 wherein the movable apparatus is a vehicle for transport over land.

17. The docking system of claim 14 wherein the movable apparatus is a vehicle for transport through the air.

18. The docking system of claim 1 further comprising means of mounting securing such system in a fixed geographical location.

19. The docking system of claim 1 further wherein the transmission of information between the docking system and at least one vehicle may occur while such vehicle is not in close proximity with the docking system.

20. The docking system of claim 19 further comprising means for transmitting information between such docking system and a receiver at a distal dock for at least one such vehicle.

21. The docking system of claim 20 further comprising means for coordinating travel to and from the docking system.

22. The docking system in claim 1 wherein the information transmitted between such docking system and at least one such vehicle is capable of controlling the flight time of, destination of, information and sample gathered by, and other operations of such vehicle.

23. The docking system of claim 1 wherein at least one such vehicle is [rotary/hovering].

24. The docking system of claim 1 wherein at least one such vehicle is [fixed wing].

25. The docking system of claim 1 wherein at least one such vehicle is [a combination of rotary/hovering and fixed wing].

26. The docking system of claim 1 further comprising means for adjusting the accommodating area of the surface to adapt to the configurative requirements of at least one such vehicle.

27. The docking system of claim 1 further comprising means for monitoring environmental conditions and other local circumstances in the geographical proximity of such docking system.

28. The docking system of claim 3 further comprising means for analyzing samples.

29. A method of communicating with and securing an unmanned aerial vehicle comprising the steps of:
transmitting at least one signal between a docking location and a distal location [main control];
transmitting at least one signal between such docking location and at least one such vehicle;
positioning at least one such vehicle in in close proximity with the docking location;
securing at least one such vehicle in close proximity with the docking location through the use of magnetic fields;
transferring as needed energy to power at least one such vehicle from the docking location.

30. The method of claim 29 further comprising the step of protecting at least one such vehicle from unfavorable environment conditions.

31. The method of claim 29 further comprising the step of extracting samples from at least one such vehicle.

32. The method of claim 31 further comprising the step storing such samples.

33. The method of claim 29 further comprising the step of preparing at least one such vehicle for deployment.

34. The method of claim 33 wherein such preparing includes the extraction of certain information from such vehicle, the uploading of information to such vehicle, inspection of the physical condition of such vehicle and the maintenance of the vehicle [cleaning].

35. The method of claim 29 wherein securing is in close proximity to the accommodating area.

36. The method of claim 29 wherein the magnetic fields lock a docking area of at least one vehicle in physical contact with a surface of the docking location.

37. The method of claim 29 wherein the signal between the docking location and the distal location [main control] is transmitted via over-the-air technology.

38. The method of claim 29 further comprising the step of securing such vehicle while the system is mounted on a movable object.

39. The method of claim 29 wherein the transmission of information between the docking location and at least one vehicle occurs while such vehicle is not in close proximity with the docking location.

40. The method of claim 39 further comprising the step of coordinating travel of at least one such vehicle to and from the docking location.

41. The method in claim 29 wherein the information transmitted between such docking location and at least one such vehicle is capable of controlling the flight time of, destination of, information and sample gathered by, and other operations of such vehicle.

42. The method of claim 29 further comprising the step of monitoring environmental conditions and other local circumstances in the geographical proximity of the docking location.

43. The method of claim 29 further comprising the step of analyzing samples.
